(19) United States
(12) Patent Application Publication
(10) Pub. No.: US 2008/0026843 A1
(43) Pub. Date: Jan. 31, 2008

(54) GAME PROGRAM, GAME DEVICE, AND GAME METHOD

(75) Inventor: Noboru Nakasaka, Tokyo (JP)

Correspondence Address: GLOBAL IP COUNSELORS, LLP, 1233 20TH STREET, NW, SUITE 700, WASHINGTON, DC, 20036-2680, US

(73) Assignee: KONAMI DIGITAL ENTERTAINMENT CO., LTD., Tokyo (JP)

(21) Appl. No.: 11/846,189

(22) Filed: Aug. 28, 2007

Related U.S. Application Data
(63) Continuation of application No. PCT/JP2006/302885, filed on Feb. 17, 2006.

(30) Foreign Application Priority Data
Mar. 30, 2005 (JP) 2005-097375

(51) Int. Cl. A63F 13/00

(52) U.S. Cl. 463/37

(57) ABSTRACT

When a touch pen is brought into contact with a lower liquid crystal monitor, a first contact position is recognized. When the touch pen is moved while kept in contact with the monitor, the position to which the pen is moved is recognized as a second contact position. A movement direction and movement distance of the touch pen are computed on the basis of data of the first contact position and the second contact position. A character rotation process is performed to rotate a character so that a nose is oriented in a specific direction in accordance with the movement direction and the movement distance of the touch pen. A character propulsion process is performed for propelling the character in the specific direction.

### CROSS-REFERENCE TO RELATED APPLICATIONS

This application is a continuation of International application No. PCT/JP2006/302885, filed on Feb. 17, 2006, which claims priority to Japanese Application No. 2005-097375, filed in Japan on Mar. 30, 2005. The entire contents of both applications are hereby incorporated herein by reference.

### BACKGROUND OF THE INVENTION

1. Field of the Invention

The present invention relates to a game program. Specifically, the present invention relates to a game program that is played with an instruction member.

2. Description of Related Art

Various video games have been proposed in the past. In various video games, all sorts of instructions can be given to a character displayed on a monitor by operating various input buttons on input units, e.g., controllers separate from a game console main body, or by operating various input buttons provided integrally on the game console main body. This type of common game device has a monitor, a game console main body separate from the monitor, and a controller separate from the game console main body. A plurality of input buttons is disposed on the controller. A portable game device has a game console main body, a liquid crystal monitor provided substantially in the middle of the game console main body, and a plurality of input buttons disposed adjacent of the liquid crystal monitor. With this type of game device, various instructions can be given to the character displayed on the monitor by operating at least one of any of the plurality of input buttons. One known example of a video game in which instructions are given to the character through input buttons in this manner is a so-called shooting game in which a player aircraft character and an enemy aircraft character are displayed on the monitor, and the player aircraft character attacks the enemy aircraft character (see Japanese Patent No. 3496149, for example).

With this type of shooting game, the player can move the player aircraft character three-dimensionally in an arbitrary direction to attack the enemy aircraft character by operating input buttons that include directional instruction buttons, propulsion instruction buttons, and attack instruction buttons. Specifically, in a game screen composed of three-dimensional space displayed on the monitor, the player can rotate the nose of the player aircraft character in the instructed direction by pressing up, down, left, and right directional instruction buttons. The player can move the player aircraft character forward in the direction in which the nose is pointing by simultaneously pressing the propulsion instruction buttons. The player can also fire, e.g., missiles, beams, or other attack methods to attack the enemy aircraft character by pressing the attack instruction buttons.

In the previously described conventional shooting game, and particularly in a shooting game in which a player aircraft character can be moved three-dimensionally in an arbitrary direction, movement direction instructions and propulsion instructions for the player aircraft character are given by operating different input buttons, which are the directional instruction buttons and the propulsion instruction buttons. When operating different input buttons in this manner, it becomes necessary to press the propulsion instruction buttons with the right hand while pressing the directional instruction buttons with the left hand, for example.

However, when both hands are operating the directional instruction buttons and the propulsion instruction buttons, it is extremely difficult to simultaneously operate other input buttons. For example, since both hands are pressing the directional instruction buttons and the propulsion instruction buttons when moving the player aircraft character, it is difficult to simultaneously press the attack command buttons, and it is therefore difficult to simultaneously attack the enemy aircraft character. Aside from the attack operations, it is also difficult to switch attack methods, and to simultaneously press other input buttons for performing a search operation to search for the enemy aircraft character.

Thus, since other input buttons cannot be simultaneously operated while both hands are operating the directional instruction buttons and the propulsion instruction buttons, the possibility arises that the operability of the game will be severely reduced. When the game is less operable, the players intended operations cannot be readily reflected in the game, and the player may therefore find the game less enjoyable.

### SUMMARY OF THE INVENTION

It is an object of the present invention to provide a game program wherein the operability of the game is improved and a high level of enjoyment in the game is maintained for the player.

The game program according to a first aspect is a game program that instructs a computer to perform the following functions:

(1) A contact position recognition function for recognizing the contact position of an instruction member on the monitor when the instruction member is brought into contact with the monitor;

(2) A movement direction recognition function for recognizing the movement direction in relation to the contact position when the instruction member is moved across the monitor;

(3) A movement distance recognition function for recognizing the movement distance from the contact position within a specific time period when the instruction member is moved across the monitor;

(4) A character rotation function for rotating a character so that the character faces a specific direction in accordance with the movement direction and the movement distance;

(5) A character propulsion function for propelling the character in a specific direction while the instruction member is in contact with the monitor; and

(6) A character display finction for displaying on the monitor the character moved by the character rotation function and the character propulsion function.

In the game run by this program, the following process is performed in the computer. First, when the instruction member comes into contact with the monitor, the contact position of the instruction member in the monitor is recognized. Next, when the instruction member moves across the monitor, the movement direction in relation to the contact position is recognized, and the movement distance from the contact position within a specific time period is recognized. A character rotation control process is then performed for rotating the character so that the character faces a specific direction in accordance with the movement direction and the movement distance, and a character propulsion control process is performed for propelling the character in the specific direction while the instruction member is in contact with the monitor. Lastly, the character moved by the character rotation control process and the character propulsion control process is displayed on the monitor.

In this game program, the player can operate the character displayed on the monitor by inputting instructions on the touch panel monitor with the aid of a touch pen, a finger, or another such instruction member. Specifically, the character can be rotated to face a specific direction in accordance with the movement direction and movement distance when the instruction member is moved across the monitor, and the character can be propelled in the specific direction while the instruction member is in contact with the monitor.

Using as an example a shooting game in which a player aircraft character can be operated, the orientation of the nose of the player aircraft character is determined according to the movement direction and movement distance when the touch pen is moved across the monitor, and the player aircraft character can be propelled in the direction in which the nose is oriented while the touch pen is in contact with the monitor.

Since the movement operation and contact operation of the touch pen can be performed with one hand, there is no need to operate the directional instruction buttons and the propulsion instruction buttons with both hands as in the past. Therefore, since the input buttons can be operated with the other hand, the touch pen can be operated with the right hand to give movement direction instructions and propulsion instructions to the player aircraft character, for example, while the attack instruction buttons can simultaneously be pressed with the left hand to attack the enemy aircraft character. Therefore, since the intended operations of the player can be readily reflected in the game, the operability of the game can be improved, and a higher level of enjoyment in the game can be maintained for the player.

The game program according to a second aspect is the game program as recited in the first aspect, wherein the character propulsion function is a function for propelling the character in the specific direction when the instruction member is brought into contact with the monitor and is not moving across the monitor. In this game program, the character can be propelled in a specific direction on the game screen even when the instruction member is not moving across the monitor while the instruction member is in contact with the monitor. Therefore, there is no need to press other propulsion instruction buttons as in the past.

The game program according to a third aspect is the game program as recited in the first or second aspect, wherein the character rotation function is a function whereby the rotational angle of the character increases as the movement distance increases. In this game program, the player can easily and intuitively operate the game because the rotational angle of the character increases proportionate to the distance by which the instruction member moves over the monitor.

The game program according to a fourth aspect is the game program as recited in any of the first through third aspects, wherein the character rotation function is a function whereby the rotational angle of the character is maintained when a specific movement distance is exceeded, and the rotational angle of the character increases from the maintained rotational angle as the movement distance increases when the instruction member is moved across the monitor to a different position than the contact position. In this game program, when, for example, the instruction member is positioned at one end of the monitor, and the instruction member is then returned to the other end of the monitor and kept moving further, the character can be rotated at the same rotational angle as before the instruction member was returned. Therefore, the movement distance of the instruction member can be increased in a small monitor.

The game program according to a fifth aspect is the game program as recited in any of the first through fourth aspects and further adding the following functions:

(7) A movement speed recognition function for recognizing the movement speed in relation to the contact position when the instruction member is moved across the monitor;

(8) A character speed variation function for varying the movement speed of the character in accordance with the movement speed in relation to the contact position; and

(9) A character speed variation display function for displaying the character moved by the character speed variation function on the monitor.

In the game run by this program, when the instruction member is moved across the monitor, the movement speed in relation to the contact position is recognized. Next, a character speed variation control process is performed for varying the movement speed of the character in accordance with the recognized movement speed. The character moved by the character speed variation control process is then displayed on the monitor.

In this game program, since the movement speed of the character can be varied according to the movement acceleration of the touch pen, the movement speed of the character can be increased when, e.g., the touch pen is moved quickly, i.e., when the movement acceleration is high.

A game device according to a sixth aspect is a game device that can run a game in which a character that can be moved by instruction member is displayed on a touch panel monitor; wherein the game device includes a contact position recognition section, movement direction recognition section, a movement distance recognition section, a character rotation section, a character propulsion section, and a character display section.

The contact position recognition section recognizes the contact position of the instruction member on the monitor when the instruction member is brought into contact with the monitor. The movement direction recognition section recognizes the movement direction in relation to the contact position when the instruction member is moved across the monitor. The movement distance recognition section recognizes the movement distance from the contact position within a specific time period when the instruction member is moved across the monitor. The character rotation section performs a character rotation control process for rotating the character so that the character faces a specific direction in accordance with the movement direction and the movement distance. The character propulsion section performs a character propulsion control process for propelling the character in a specific direction while the instruction member is in contact with the monitor. The character display section displays the character moved by the character rotation control process and the character propulsion control process on the monitor.

A game method according to a seventh aspect includes a contact position recognition step, a movement direction recognition step, a movement distance recognition step, a character rotation step, a character propulsion step, and a character display step.

The contact position recognition step recognizes the contact position of the instruction member on the monitor when the instruction member is brought into contact with the monitor. The movement direction recognition step recognizes the movement direction in relation to the contact position when the instruction member is moved across the monitor. The movement distance recognition step recognizes the movement distance from the contact position within a specific time period when the instruction member is moved across the monitor. The character rotation step performs a character rotation control process for rotating a character so that the character faces a specific direction in accordance with the movement direction and the movement distance. The character propulsion step performs a character propulsion control process for propelling the character in a specific direction while the instruction member is in contact with the monitor. The character display step displays on the monitor the character moved by the character rotation control process and the character propulsion control process on the monitor.

### BRIEF DESCRIPTION OF THE DRAWINGS

FIG. 1 is an external view of a portable game console as one example of a computer in which a game program according to the present invention is implemented;

FIG. 2 is a control block diagram as one example of the portable game console;

FIG. 3 is a function block diagram as one example of the portable game console;

FIG. 4A is a diagram showing a display screen of an upper liquid crystal monitor in the shooting game;

FIG. 4B is a diagram of the contact operation of a touch pen on a lower liquid crystal monitor;

FIG. 5 is a diagram showing a display screen on the upper liquid crystal monitor with a different viewpoint than FIG. 4;

FIG. 6 is a diagram showing the contact operation of the touch pen on the lower liquid crystal monitor;

FIG. 7 is a schematic view showing the movement operation of the player aircraft character on the upper liquid crystal monitor in FIG. 6;

FIG. 8 is a diagram equivalent to FIG. 6 for a case in which the touch pen is moving to the right;

FIG. 9 is a diagram equivalent to FIG. 7 is FIG. 8;

FIG. 10 is a diagram equivalent to FIG. 6 for a case in which the touch pen is moving upward;

FIG. 11 is a diagram equivalent to FIG. 7 in FIG. 10;

FIG. 12 is a diagram equivalent to FIG. 6 for a case in which the touch pen is moving upward and to the right;

FIG. 13 is a diagram equivalent to FIG. 7 in FIG. 12;

FIG. 14 is a diagram equivalent to FIG. 6 for a case in which the touch pen is moving to the right over a shorter movement distance;

FIG. 15 is a diagram equivalent to FIG. 7 in FIG. 14;

FIG. 16 is a flowchart for describing a character display system in the shooting game;

FIG. 17 is a function block of a portable game console according to a second embodiment; and

FIG. 18 is a flowchart for describing a character display system according to the second embodiment.

### DETAILED DESCRIPTION

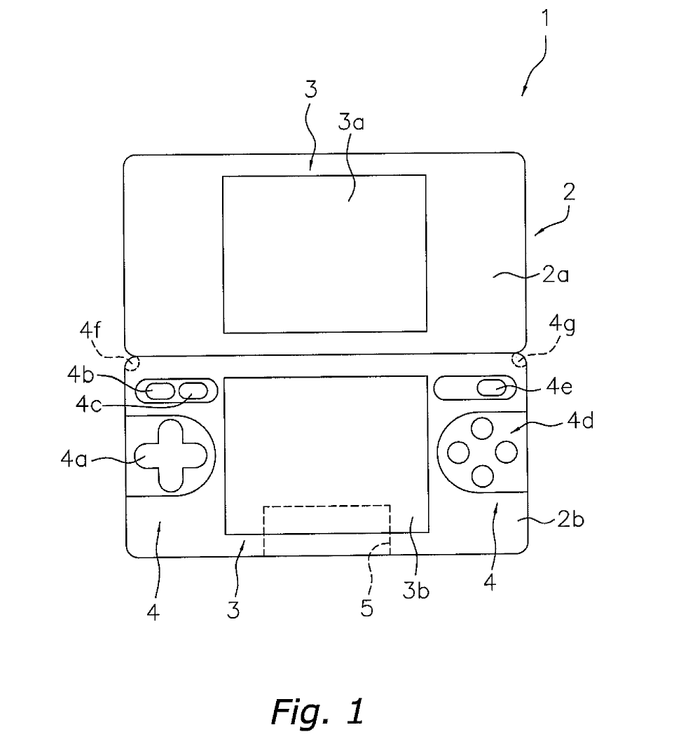

Referring to FIGS. 1-3, a portable game console 1 includes a main body 2, a liquid crystal monitor 3, an input unit 4, a cartridge slot 5, and a communication unit 6, as shown in FIG. 1. The main body 2 has an upper casing 2a and a lower casing 2b. The upper casing 2a and the lower casing 2b are linked together and can be opened and closed relative to each other. The liquid crystal monitor 3 is composed of an upper liquid crystal monitor 3a provided in the upper casing 2a, and a lower liquid crystal monitor 3b provided in the lower casing 2b. The upper liquid crystal monitor 3a is a non-touch panel monitor, and the lower liquid crystal monitor 3b is a touch panel monitor, for example. The non-touch panel monitor 3a is composed of a liquid crystal panel, and the touch panel monitor 3b is composed of a liquid crystal panel and a touch panel. In the touch panel monitor 3b, the display surface of the liquid crystal panel and the data input surface of the touch panel are laminated and integrated with each other. The input unit 4 includes of a directional instruction button 4a in the shape of a cross disposed in the left center of the lower casing 2b, a select button 4b and start button 4c disposed side by side in the upper left of the lower casing 2b, instruction buttons 4d disposed in the right center of the lower casing 2b, a power button 4e disposed in the upper right of the lower casing 2b, and an L button 4f and R button 4g disposed in the left and right comers of the lower casing 2b. The cartridge slot 5 is provided in a lower portion of the lower casing 2b. A game cartridge, for example, can be inserted into the cartridge slot 5. The communication unit 6 is housed within, e.g., the upper casing 2a of the main body 2. The communication unit 6 is provided with, e.g., a Local Wireless Network function, an internet connecting function that uses a wireless LAN, or the like. The portable game console 1 is also provided with a volume control button, and earphone jack, and other components, but these are not described herein.

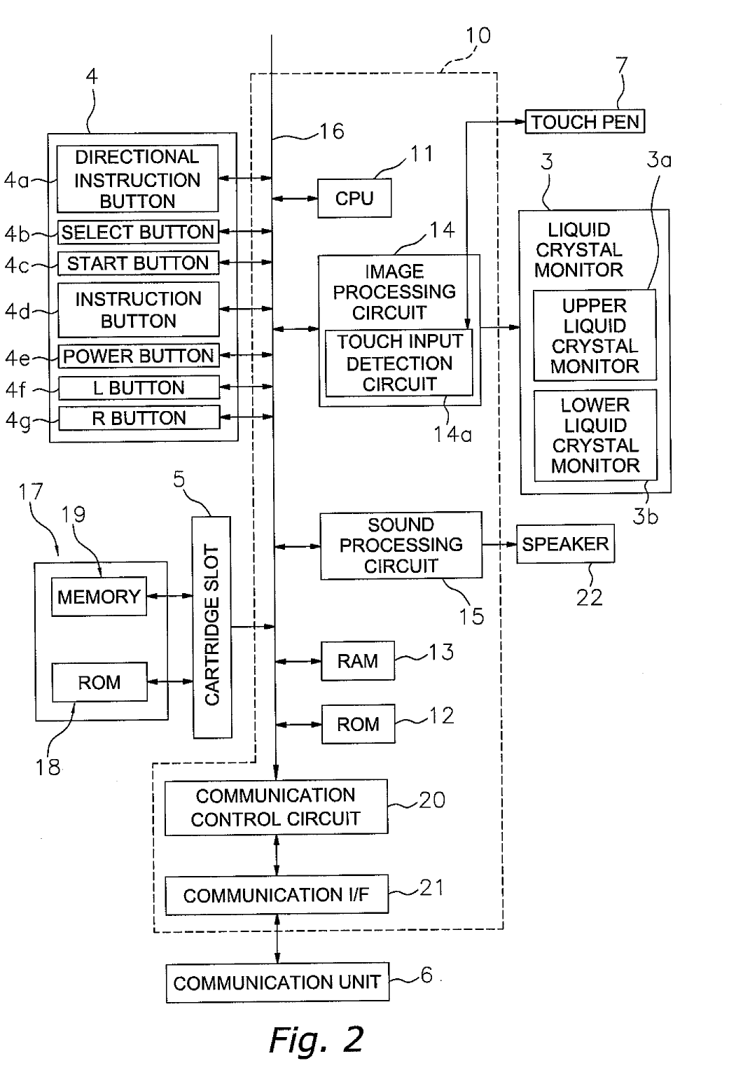

The portable game console 1 further includes a control device 10 in the interior, as shown in FIG. 2. In this control device 10, a CPU 11 (Central Processing Unit) that uses a microprocessor, a ROM 12 (Read Only Memory) as a primary storage device, a RAM 13 (Random Access Memory), an image processing circuit 14, a sound processing circuit 15, and a communication control circuit 20 are connected together via a bus 16.

The CPU 11 interprets commands from the game program and performs various data processes and controls. The ROM 12 stores programs and the like needed for essential controls (e.g., startup control and the like) in the portable game console 1. The RAM 13 provides a working environment for the CPU 11. The image processing circuit 14 controls the liquid crystal monitor 3 in accordance with rendering instructions from the CPU 11, and displays specific images on at least one of the upper liquid crystal monitor 3a and the lower liquid crystal monitor 3b. The image processing circuit 14 includes a touch input detection circuit 14a. When a touch pen 7, finger, or the like as instruction member is brought into direct contact with the touch panel, coordinate data of the contact position is supplied from the touch input detection circuit 14a to the CPU 11, and the contact position is recognized in the CPU 11. When the touch pen 7 is brought into direct contact with the touch panel at the position of an object displayed on the liquid crystal panel, the coordinate data of the object is supplied from the touch input detection circuit 14a to the CPU 11, and the object is recognized in the CPU. The sound processing circuit 15 creates an analog voice signal corresponding to a speech instruction from the CPU 11, and outputs the signal to a speaker 22.

The communication control circuit 20 is used to wirelessly connect the portable game console 1 to other game consoles and the like. The communication control circuit 20 is connected to the CPU 11 via the bus 16. The communication control circuit 20 controls and generates connection signals for connecting the portable game console 1 to the Internet by a Local Wireless Network or a Wireless LAN.

An external storage device 17 separate from the control device 10 is connected to the bus 16. An example of an external storage device 17 is a game cartridge that can be inserted into and removed from, e.g., the lower casing 2b of the main body 2. The external storage device 17 includes a ROM 18 and memory 19 as re-writeable user memory. A game program for allowing the portable game console 1 to finction as a computer, as well as various data needed to run the game program are recorded in advance in the ROM 18. This various data contains various character image data, including, for example, various panel image data, attribute image data, and other such data. Re-writeable memory such as flash memory, for example, may be used for the memory 19. Game saved data or other such data, for example, is recorded as necessary in the memory 19. The storage medium of the external storage device 17 is not limited to a semiconductor storage element, and other options include a magnetic storage medium, an optical storage medium, a magneto-optical storage medium, and various other recording media. In addition to a cartridge, possible examples of this recording medium include, e.g., a computer-readable flexible disk, semiconductor memory, a CD-ROM, a DVD, a UMD, a ROM cassette, and others. An interface circuit is provided as necessary between the bus 16 and the other elements, but this circuit is not illustrated herein.

In the portable game console 1 configured as described above, the game program recorded in the ROM 18 of the external storage device 17 is loaded, and the loaded game program is run by the CPU 11, whereby the player can run games of various genres on the liquid crystal monitor 3. The portable game console 1 is connected to a wireless network via the communication control circuit 20 or is connected to another game console via a communication cable or the like, whereby data can be exchanged or fighting games can be played with the other game console.

[Overview of Various Processes in Game Device]

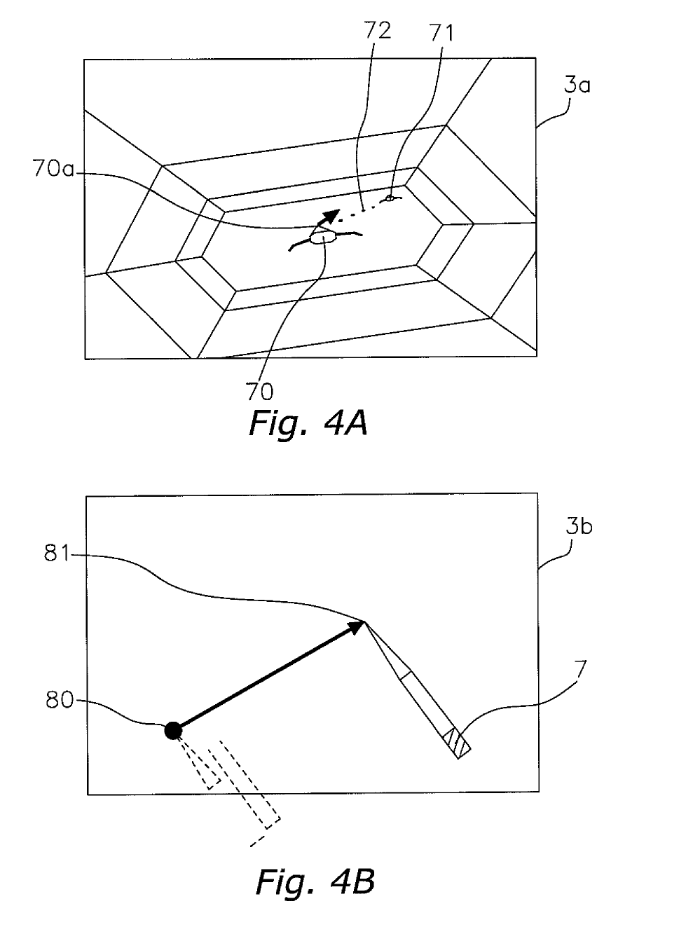

Referring to FIG. 4A, an example of the game program run in the portable game console 1 is a shooting game wherein the player can operate a player aircraft character 70 to attack an enemy aircraft character 71.

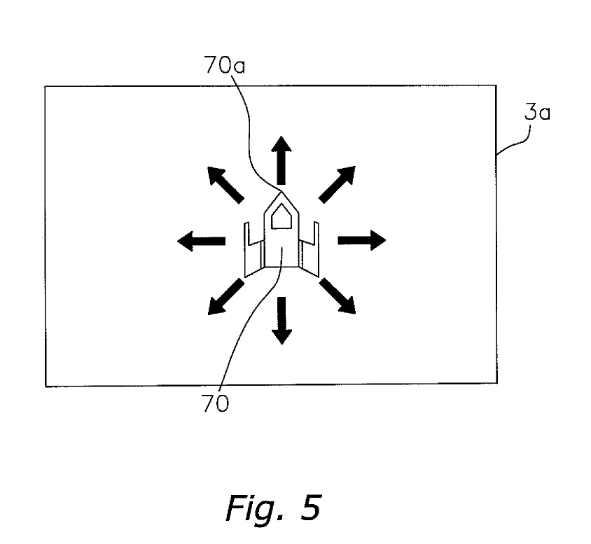

In the portable game console 1, the player aircraft character 70 is displayed on the upper liquid crystal monitor 3a. Contact from the touch pen 7 is inputted to the touch panel lower liquid crystal monitor 3b. Other characters are not displayed on the lower liquid crystal monitor 3b, as shown in FIG. 4B. In the upper liquid crystal monitor 3a, it is possible to switch the display between a three-dimensional screen from the player's viewpoint shown in FIG. 4A, and a two-dimensional screen, as shown in FIG. 5, in which the player aircraft character 70 is seen from above. As shown in FIG. 5, the player aircraft character 70 can move in an arbitrary direction including vertical, transverse, and diagonal (in the directions of the arrows in FIG. 5), as well as longitudinal and diagonal (not shown) (in the direction from front to back relative to the paper surface in FIG. 5). A nose 70a is designed to be oriented in the direction of movement. The player aircraft character 70 can attack the enemy aircraft character 71 by firing missiles, beams, or other such attack methods 72 toward the enemy aircraft character 71, as shown in FIG. 4A.

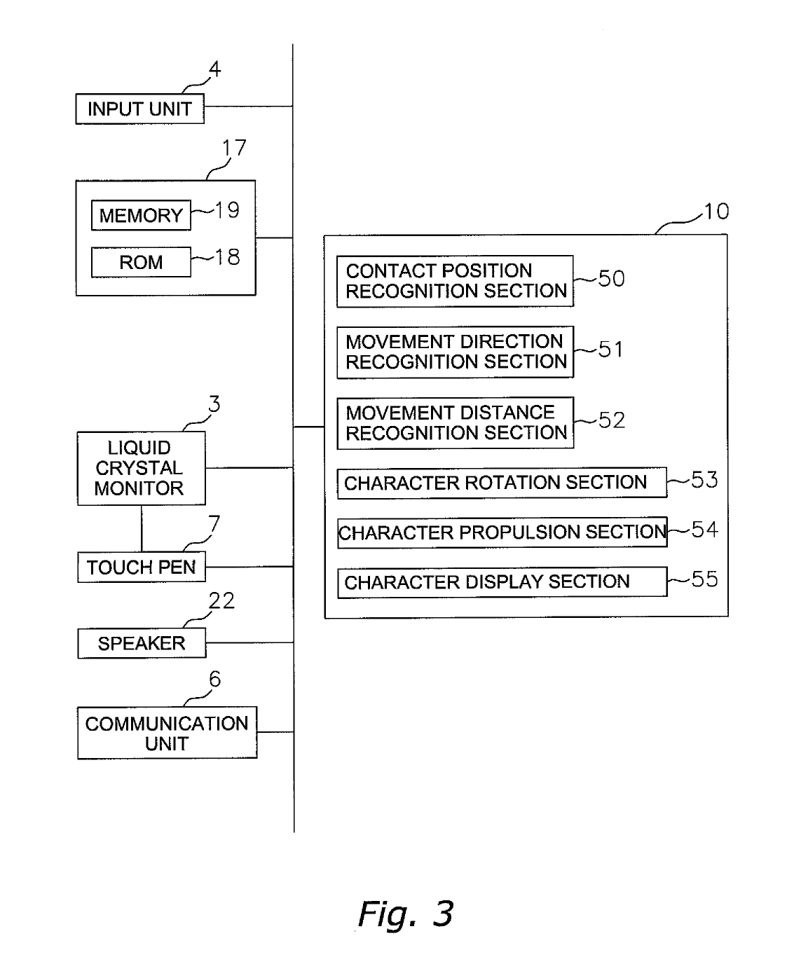

The control device 10 of the portable game console 1 includes a contact position recognition section 50, a movement direction recognition section 51, a movement distance recognition section 52, a character rotation section 53, a character propulsion section 54, and a character display section 55, as shown in FIG. 3.

The contact position recognition section 50 recognizes a contact position of the touch pen 7 in the lower liquid crystal monitor 3b when the touch pen 7 contacts the lower liquid crystal monitor 3b. Coordinate data of the contact position of the touch pen 7 is supplied from the touch input detection circuit 14a to the CPU 11, and the contact position of the touch pen 7 is recognized in the CPU 11. Referring to FIG. 4B, the position where the touch pen 7 first comes into contact is recognized as a first contact position 80, and an upper right position, for example, to which the touch pen 7 has moved in a specific time period is recognized as a second contact position 81. The contact position of the touch pen 7 is initialized each time the touch pen 7 moves but the first contact position 80 and the second contact position 81 are stored together with time data as coordinate data in the RAM 13.

The movement direction recognition section 51 recognizes the movement direction in relation to the contact position when the touch pen 7 moves across the lower liquid crystal monitor 3b. In the movement direction recognition section 51, when the touch pen 7 moves across the lower liquid crystal monitor 3b, the CPU 11 computes the movement direction as a vector on the basis of the coordinate data of the first contact position 80 and second contact position 81 recognized by the contact position recognition section 50, and the computation results are stored in the RAM 13. This movement direction refers to the movement direction of the touch pen 7, and not to the movement direction of the player aircraft character 70.

The movement distance recognition section 52 recognizes the movement distance between the first contact position 80 and the second contact position 81 in a specific time period when the touch pen 7 is moved across the lower liquid crystal monitor 3b. In the movement distance recognition section 52, the CPU 11 computes the movement distance between the first contact position 80 and the second contact position 81 on the basis of the coordinate data of the first contact position 80 and second contact position 81 recognized by the contact position recognition section 50 when the touch pen 7 moves across the lower liquid crystal monitor 3b, and the computation results are stored in the RAM 13. The specific time period is a constant interval stipulated by, e.g., a timer (not shown) provided to the CPU 11. This time period can be set to any arbitrary time period less than a time calculated by dividing the maximum movement distance of the touch pen 7 (for example, the length of the diagonal or the length of the sides of the lower liquid crystal monitor 3b; twice the length of the sides, which indicates the two-way movement distance of the touch pen 7; or the like) by the maximum movement speed of the touch pen 7.

The character rotation section 53 rotates the player aircraft character 70 so that the player aircraft character 70 is oriented in a specific direction in accordance with the movement direction recognized by the movement direction recognition section 51 and the movement distance recognized by the movement distance recognition section 52. In the character rotation section 53, the rotational direction of the player aircraft character 70 is set depending on the movement direction of the touch pen 7 stored in the RAM 13. For example, the player aircraft character 70 is rotated to the right (clockwise) in cases in which the upper right direction shown in FIG. 4B is set. The character rotation section 53 is designed so that the rotational angle of the player aircraft character 70 increases as the movement distance increases. The CPU 11 computes the rotational angle of the player aircraft character 70 in accordance with a specific computation table so that the rotational angle of the player aircraft character 70 is proportionate to the movement distance of the touch pen 7, and the computation results are stored in the RAM 13. The specific computation table is stored in the ROM 18, and is also stored in the RAM 13 and computed together with the movement distance of the touch pen 7 by the CPU 11. In FIG. 4A, the nose 70a of the player aircraft character 70 is oriented towards the upper right; i.e., towards the enemy aircraft character 71.

The character propulsion section 54 propels the player aircraft character 70 towards the angle computed by the character rotation section 53, or, specifically, so that the nose 70a is oriented towards the upper right; i.e., towards the enemy aircraft character 71.

The character display section 55 displays the player aircraft character 70 moved by the character rotation section 53 and the character propulsion section 54 is displayed on the upper liquid crystal monitor 3a. The character display section 55 then displays the player aircraft character 70 on the upper liquid crystal monitor 3a while the nose 70a of the player aircraft character 70 is oriented towards the angle computed by the character rotation section 53, or, specifically, towards the enemy aircraft character 71, and while the entire player aircraft character 70 is moving towards the enemy aircraft character 71.

Since the movement operation and contact operation of the touch pen 7 can be performed with one hand, the rest of the input unit 4 can be operated with the other hand. Therefore, the touch pen 7 can be operated with the right hand to give movement direction instructions and propulsion instructions for the player aircraft character 70, while the buttons of the input unit 4 can be simultaneously pressed with the left hand to attack the enemy aircraft character 71. Therefore, since the intended operations of the player can be readily reflected in the game, the operability of the game can be improved, and a high level of enjoyment in the game can be maintained for the player.

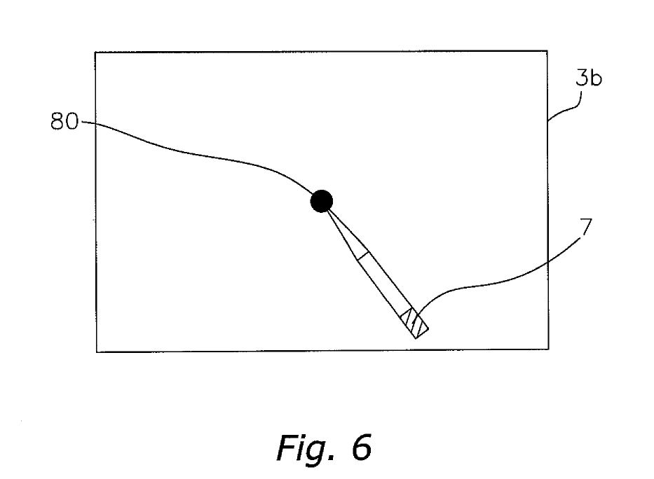

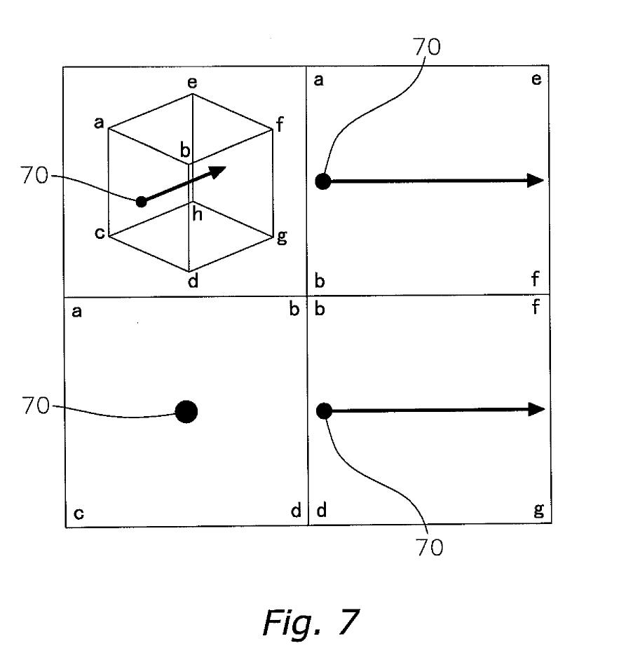

The following is a description made with reference to FIGS. 6 through 15 of the specific manner in which the player aircraft character 70 moves depending on the method of moving the touch pen 7. FIGS. 6, 8, 10, 12, and 14 show the contact operation of the touch pen 7 on the lower liquid crystal monitor 3b. The arrows indicate the contact movement trajectory of the touch pen 7, and the black circles indicate the contact of the touch pen 7. FIGS. 7, 9, 11, 13, and 15 show the movement operation of the player aircraft character 70 on the upper liquid crystal monitor 3a. The cube in the upper left diagram of each of FIGS. 7, 9, 11, 13 and 15 indicate virtual game airspace. The movement trajectory projected from three sides of the cube is shown in the other three diagrams of each of FIGS. 7, 9, 11, 13 and 15. The arrows indicate the movement trajectory of the player aircraft character 70, and the orientations of the distal ends of the arrows indicate the orientation of the nose 70a of the player aircraft character 70.

When the touch pen 7 is kept in contact at the first contact position 80 on the lower liquid crystal monitor 3b, the player aircraft character 70 does not rotate from an initial position prior to the contact of the touch pen 7, but advances forward in the direction of the nose 70a (the direction of the arrow), as shown in FIGS. 6 and 7. Specifically, in the plane abcd, the nose 70a is oriented from the substantial center of the plane abcd to the substantial center of the plane ehgf, and is disposed parallel to the edges ae, bf, ch, and dg, as shown in FIG. 7. Therefore, when the touch pen 7 is kept in contact with the first contact position 80, the player aircraft character 70 is propelled straight from the substantial center of the plane abcd to the substantial center of the plane ehgf. In FIG. 6, the first contact position 80 is in the substantial center of the lower liquid crystal monitor 3b, but the player aircraft character 70 is propelled straight from the substantial center of the plane abcd to the substantial center of the plane ehgf when the first contact position 80 is disposed in an arbitrary position on the lower liquid crystal monitor 3b and the touch pen 7 is brought into contact.

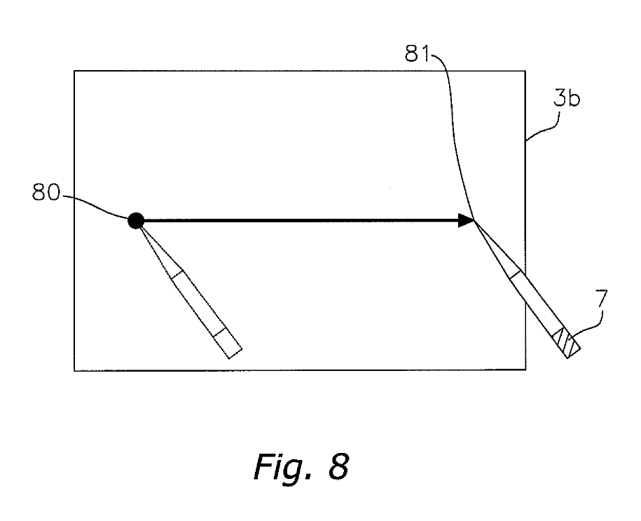

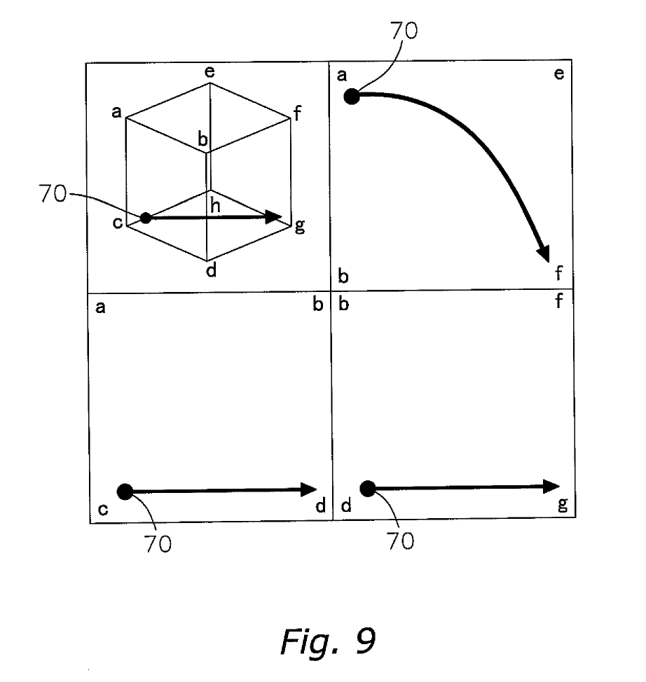

Referring to FIGS. 8 and 9, when the touch pen 7 is kept in contact and moved to the right from the first contact position 80 to the second contact position 81 on the lower liquid crystal monitor 3b, the player aircraft character 70 rotates to the right from an initial position prior to the contact of the touch pen 7 in accordance with the movement distance of the touch pen 7, and the player aircraft character 70 advances in the rotational direction of the nose 70a (in the direction of the arrow), as shown in FIGS. 8 and 9. Specifically, the nose 70a is initially disposed in the lower left part of plane abed so as to be parallel to the edges ae, bf, ch, and dg, as shown in FIG. 9. Therefore, when the touch pen 7 is kept in contact and moved from the first contact position 80 to the second contact position 81, the player aircraft character 70 faces from the lower left part of the plane abed towards the lower right part of the plane bdgf and rotates to the right in the plane cdgh while advancing in an arc. In FIG. 8, the line connecting the first contact position 80 and the second contact position 81 is disposed in the substantial middle of the lower liquid crystal monitor 3b so as to be parallel to the upper and lower edges of the lower liquid crystal monitor 3b. The line advances in a similar arc if the first contact position 80 is disposed at an arbitrary position in the lower liquid crystal monitor 3b, the touch pen 7 is moved to the right so as to be parallel to the upper and lower edges of the lower liquid crystal monitor 3b, and the length of the line connecting the first contact position 80 and the second contact position 81, i.e., the movement distance of the touch pen 7, is the same.

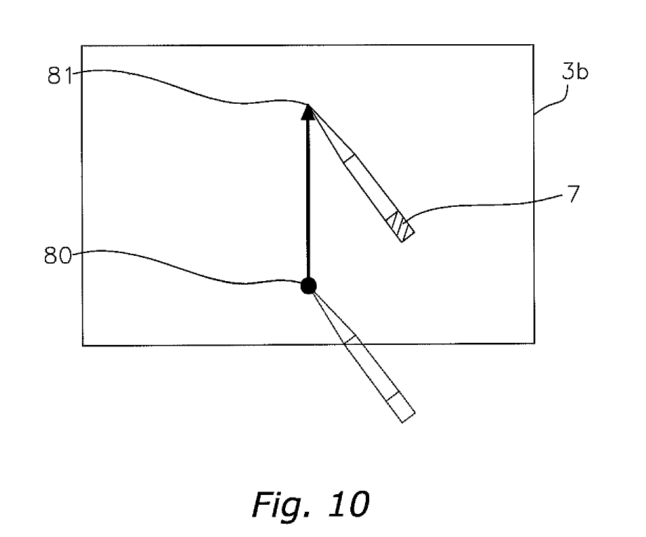

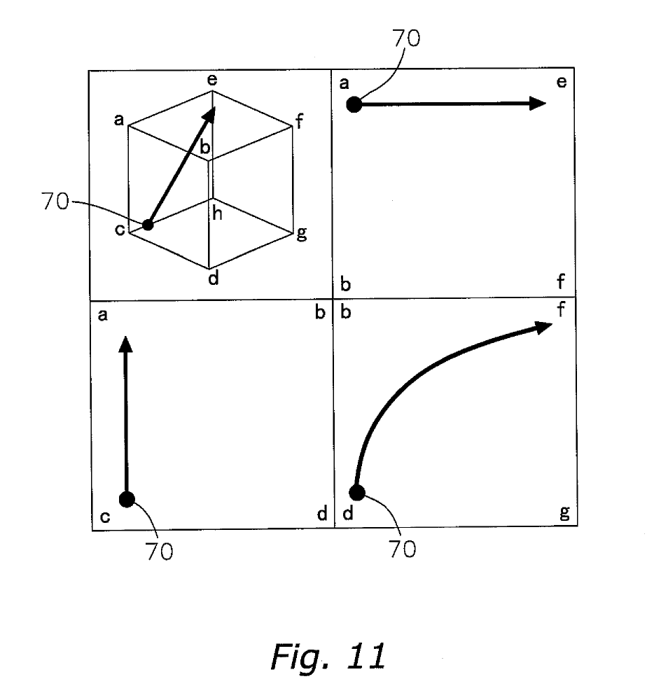

When the touch pen 7 is kept in contact and moved upward from the first contact position 80 to the second contact position 81 on the liquid crystal monitor 3, the player aircraft character 70 rotates to the right from the initial position prior to the contact of the touch pen 7 in accordance with the movement distance of the touch pen 7, and advances in the rotational direction of the nose 70a (the direction of the arrow), as shown in FIGS. 10 and 11. Specifically, the nose 70a is initially disposed in the lower left part of plane abed so as to be parallel to the edges ae, bf, ch, and dg, as shown in FIG. 11. Therefore, when the touch pen 7 is kept in contact and moved from the first contact position 80 to the second contact position 81, the player aircraft character 70 faces from the lower left part of the plane abcd towards the upper right part of the plane abfe and advances in an arc while rotating to the right in the plane ache. In FIG. 10, the line connecting the first contact position 80 and the second contact position 81 is disposed in the substantial middle of the lower liquid crystal monitor 3b so as to be parallel to the left and right edges of the lower liquid crystal monitor 3b. The line advances in a similar arc if the first contact position 80 is disposed at an arbitrary position in the lower liquid crystal monitor 3b, the touch pen 7 is moved upward so as to be parallel to the upper and lower edges of the lower liquid crystal monitor 3b, and the length of the line connecting the first contact position 80 and the second contact position 81, i.e., the movement distance of the touch pen 7, is the same.

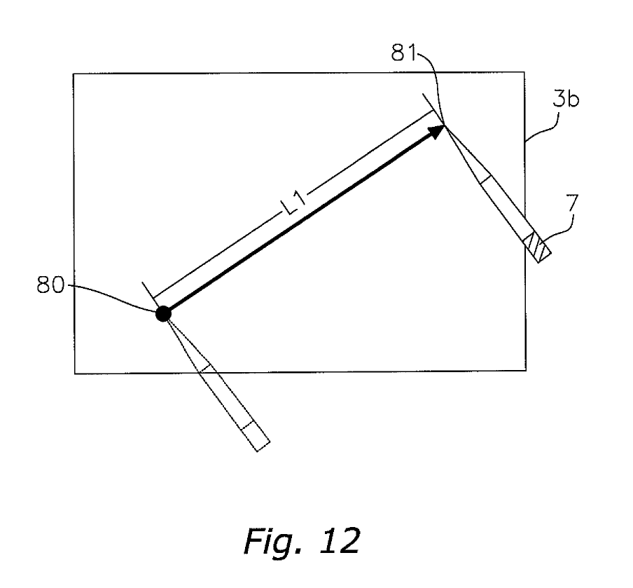

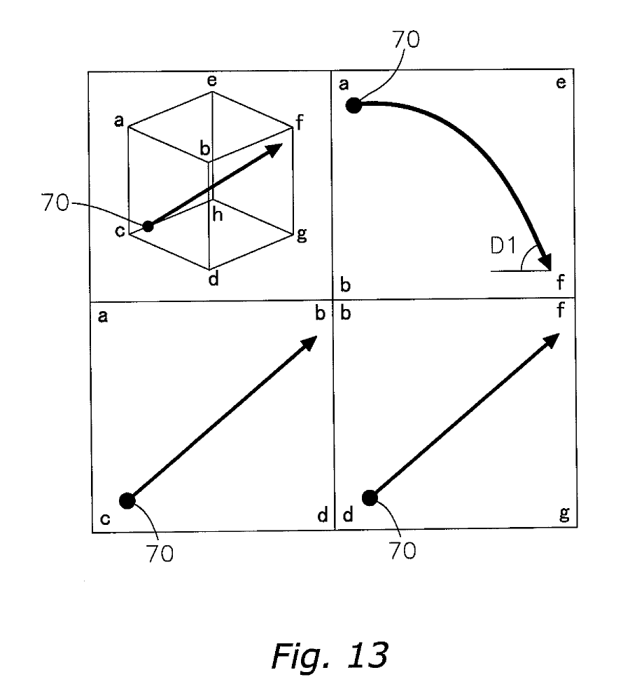

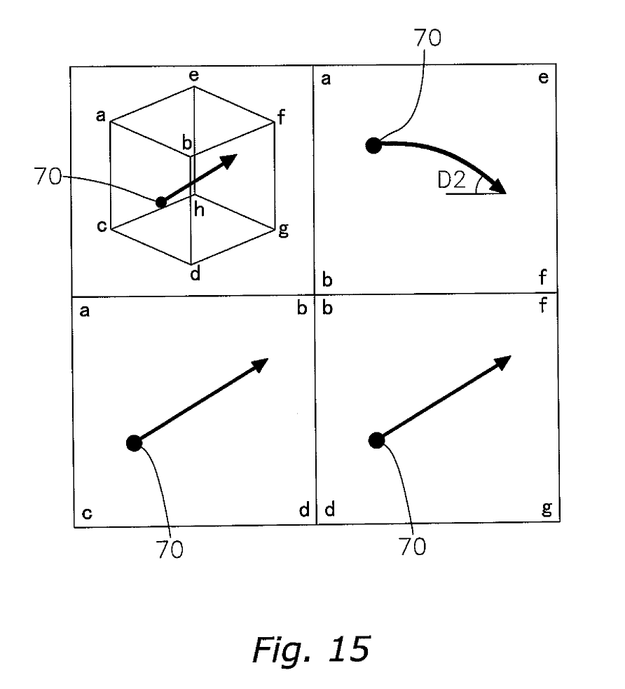

When the touch pen 7 is kept in contact and moved upward and to the right from the first contact position 80 to the second contact position 81 on the lower liquid crystal monitor 3b, the player aircraft character 70 rotates to the right from an initial position prior to the contact of the touch pen 7 in accordance with the movement distance of the touch pen 7, and advances in the rotational direction of the nose 70a (the direction of the arrow), as shown in FIGS. 12, 13, 14, and 15. Specifically, the nose 70a is initially disposed in the lower left part of plane abcd so as to be parallel to the edges ae, bf, ch, and dg, as shown in FIGS. 13 and 15. Therefore, when the touch pen 7 is kept in contact and moved from the first contact position 80 to the second contact position 81, the player aircraft character 70 faces from the lower left part of the plane abcd towards the upper right part of the plane bdgf and advances in an arc while rotating to the right within the space abcdefgh.

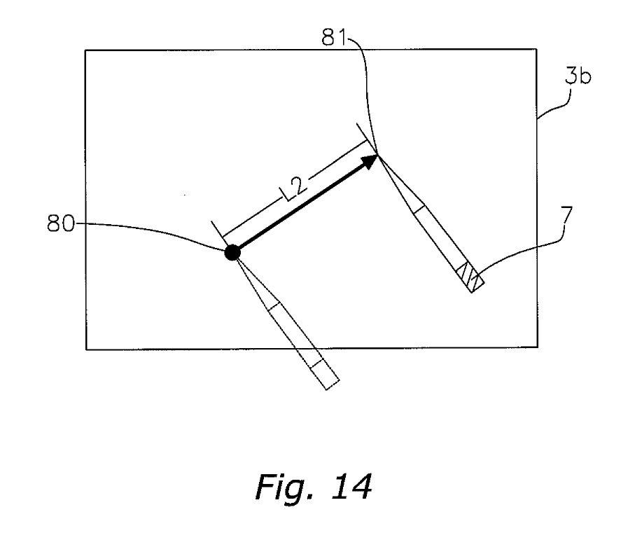

When the touch pen 7 is moved over a movement distance L1 from the first contact position 80 to the second contact position 81, as shown in FIG. 12, the player aircraft character 70 rotates by a rotational angle D1 to the right, as shown in FIG. 13. Similarly, when the touch pen 7 is kept in contact and moved to the right from the first contact position 80 to the second contact position 81 over a movement distance L2 that is shorter than the movement distance L1, as shown in FIG. 14, the player aircraft character 70 rotates to the right by a rotational angle D2 that is smaller than the rotational angle D1, as shown in FIG. 15. Specifically, the rotational angle of the player aircraft character 70 increases as the movement distance of the touch pen 7 increases.

In FIGS. 12 and 14, the line connecting the first contact position 80 and the second contact position 81 extends towards the upper right of the lower liquid crystal monitor 3b and is disposed in the substantial middle of the lower liquid crystal monitor 3b. The line advances in a similar arc if the first contact position 80 is disposed at an arbitrary position on the lower liquid crystal monitor 3b, the touch pen 7 is moved to the upper right so as to be parallel to the line extending towards the upper right of the lower liquid crystal monitor 3b, and the length of the line connecting the first contact position 80 and the second contact position 81, i.e., the movement distance of the touch pen 7, is the same.

The player aircraft character 70 rotates to the left when the touch pen 7 is kept in contact and moved to the left, downward, or downward and to the left.

Next, the specific details of the shooting game will be described.

This shooting game is a game in which the player can operate the player aircraft character 70 to attack the enemy aircraft character 71 as shown in FIG. 4A. The player aircraft character 70 can be moved in an arbitrary direction by using the tactile operation and movement operation of the touch pen 7. Missiles, beams, or other such attack methods 72 can be fired at the enemy aircraft character 71 by utilizing the input unit 4. This is a game in which the player strives to accumulate points obtained by attacking the enemy aircraft character 71 with the player aircraft character 70 while avoiding the attacks of the enemy aircraft character 71. The attack method and point computation method of this shooting game are the same as typical conventional methods and are therefore not described in detail.

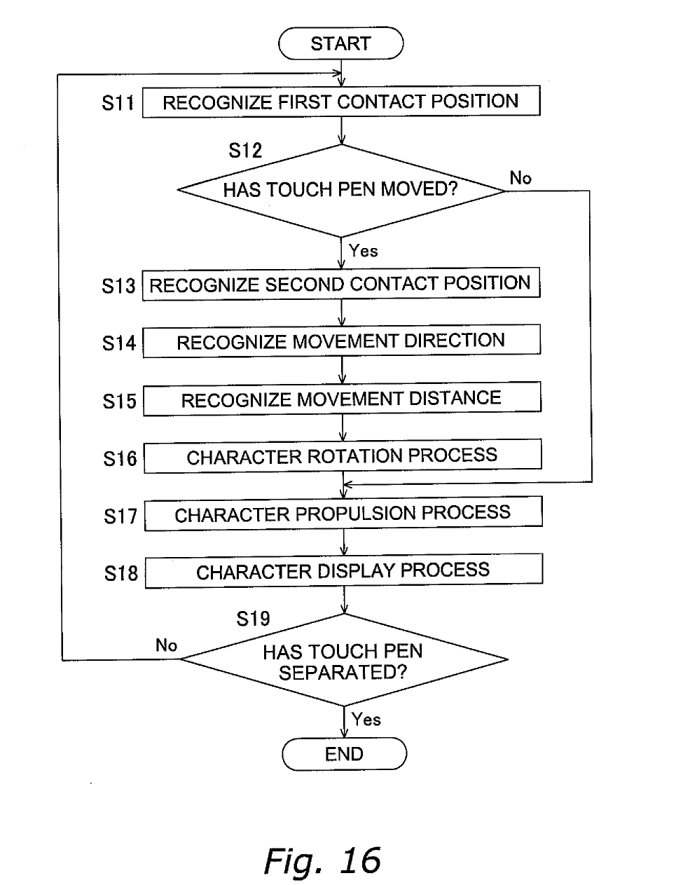

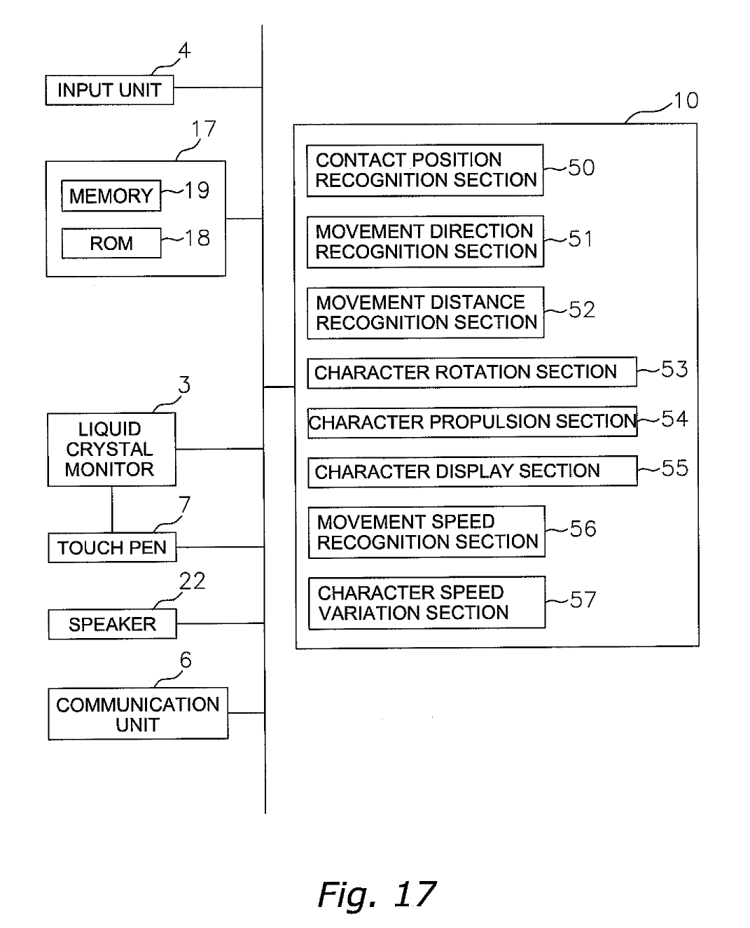

The flowchart shown in FIG. 16 is used to describe a character display system related to the movement of the player aircraft character 70 in the shooting game.

This shooting game begins from a state in which the player aircraft character 70 is displayed on the upper liquid crystal monitor 3a in the three-dimensional image from the player's viewpoint shown in FIG. 4A. At this time, input can be received through contact with the touch pen 7, a finger, or the like on the lower liquid crystal monitor 3b. When the player wishes to move the player aircraft character 70, the player brings the touch pen 7 into contact with the lower liquid crystal monitor 3b at an arbitrary position. When the touch pen 7 is brought into contact with the lower liquid crystal monitor 3b, the position of first contact is recognized as the first contact position 80 (S11), as shown in FIG. 16. A determination is then made as to whether or not the touch pen 7 has moved (S12).

When it is determined in step S12 that the touch pen 7 has moved, the first position to which the touch pen 7 has moved while in contact with the monitor is recognized as the second contact position 81 (S13). When the second contact position 81 is recognized, the movement direction of the touch pen 7 is computed as a vector on the basis of the data of the first contact position 80 and the second contact position 81 (S14). The movement distance of the touch pen 7 is then computed based on the data of the first contact position 80 and the second contact position 81 (S15). When the movement direction and movement distance of the touch pen 7 are calculated, a character rotation process is performed to rotate the player aircraft character 70 so that the nose 70a is oriented in a specific direction in accordance with the movement direction and movement distance of the touch pen 7 (S16). In this character rotation process, the rotational direction of the player aircraft character 70 is set to the right (clockwise) and the rotational angle of the player aircraft character 70 increases with increased movement distance of the touch pen 7 in cases in which, for example, the upper right direction shown in FIG. 4B is set by the movement direction of the touch pen 7. In FIG. 4A, the nose 70a of the player aircraft character 70 is oriented somewhat upward and to the right, i.e., towards the enemy aircraft character 71. When the character rotation process is performed, a character propulsion process is performed to propel the player aircraft character 70 in a specific direction. The player aircraft character 70 is propelled so as to be oriented towards the enemy aircraft character 71 (S17). The player aircraft character 70 that has moved according to the results of the character rotation process and the character propulsion process is then displayed on the upper liquid crystal monitor 3a (S18). FIG. 4A shows an image in which the nose 70a of the player aircraft character 70 advances towards the enemy aircraft character 71.

When the touch pen 7 is kept in contact with the monitor without moving in step S12, a character propulsion process is performed to propel the player aircraft character 70 without rotating the player aircraft character 70 (S17). The player aircraft character 70 that has moved according to the results of the character propulsion process is then displayed on the upper liquid crystal monitor 3a (S18). FIGS. 6 and 7 show images in which the nose 70a of the player aircraft character 70 is propelled without rotating.

Lastly, a determination is made as to whether or not the touch pen 7 has separated from the lower liquid crystal monitor 3b (S19). When the touch pen 7 has not separated from the lower liquid crystal monitor 3b, the current first contact position 80 is reset, the process moves to step S12, and the current second contact position 81 is recognized as the new first contact position 80. When the touch pen 7 has separated from the lower liquid crystal monitor 3b, the current first contact position 80 and the second contact position 81 are reset and the process is ended.

In the shooting game processed in this manner, the touch pen 7 can be operated with the right hand to give movement direction instructions and propulsion instructions for the player aircraft character 70, while the input unit 4 can be simultaneously used with the left hand to attack the enemy aircraft character 71. Therefore, since the intended operations of the player can be readily reflected in the game, the operability of the game can be improved, and a high level of enjoyment in the game can be maintained for the player.

### [OTHER EMBODIMENTS]

A portable game console 1 was used as an example of a computer capable of applying the game program. However, it will be apparent to one of ordinary skill in the art from this disclosure that the invention can also be applied to a game device wherein the monitor is configured separately, an arcade video game machine wherein the monitor is configured integrally, a personal computer or workstation made to function as a game device by running the game program, and the like.

### SECOND EMBODIMENT

A portable game console 1 of the second embodiment is the same as the portable game console 1 of the first embodiment except that the portable game console 1 of the second embodiment has a control device 10 that further includes a movement speed recognition section 56 and a character speed variation section 57.

The movement speed recognition section 56 recognizes movement speed in relation to a contact position 80 when the touch pen 7 is moved across the lower liquid crystal monitor 3b. In the movement speed recognition section 56, when the touch pen 7 is moved across the lower liquid crystal monitor 3b, the CPU 11 computes the movement speed between the first contact position 80 and a second contact position 81 on the basis of coordinate data of the first contact position 80 and the second contact position 81 recognized by the contact position recognition section 50, and the computation results are stored in the RAM 13.

The character speed variation section 57 varies the movement speed of the player aircraft character 70 in accordance with the movement speed of the touch pen 7. Depending on the movement speed of the touch pen 7 stored in the RAM 13, the character speed variation section 57 causes the movement acceleration of the player aircraft character 70 to increase when, for example, the movement speed of the touch pen 7 is greater than a specific set value. For example, when the movement speed of the player aircraft character 70 is high, the character display section 55 displays a blur of motion around the periphery of the player aircraft character 70 to demonstrate that the acceleration of the player aircraft character 70 has increased.

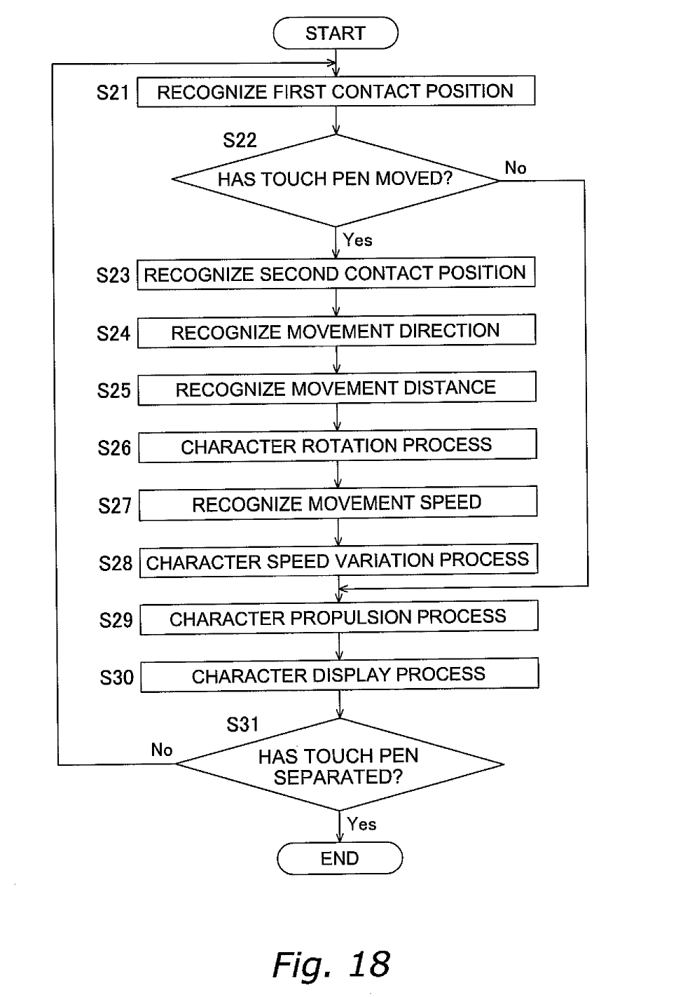

Next, the flowchart shown in FIG. 18 is used to describe a character display system related to the movement of the player aircraft character 70 in a shooting game.

This shooting game begins with the player aircraft character 70 displayed on the upper liquid crystal monitor 3a in the three-dimensional image from the player's viewpoint as shown in FIG. 4A. At this time, input can be received through contact with the touch pen 7, a finger, or the like on the lower liquid crystal monitor 3b. When the player wishes to move the player aircraft character 70, the player brings the touch pen 7 into contact at an arbitrary position on the lower liquid crystal monitor 3b. When the touch pen 7 is brought into contact with the lower liquid crystal monitor 3b, the position of the first contact is recognized as the first contact position 80 (S21). A determination is then made as to whether or not the touch pen 7 has moved (S22).

When it is determined in step S22 that the touch pen 7 has moved, the first position that the touch pen 7 has moved to while in contact is recognized as the second contact position 81 (S23). When the second contact position 81 is recognized, the movement direction of the touch pen 7 is computed as a vector on the basis of the data of the first contact position 80 and the second contact position 81 (S24). The movement distance of the touch pen 7 is then computed on the basis of the data of the first contact position 80 and the second contact position 81 (S25). When the movement direction and movement distance of the touch pen 7 are calculated, a character rotation process is performed to rotate the player aircraft character 70 so that the nose 70a is oriented in a specific direction in accordance with the movement direction and movement distance of the touch pen 7 (S26). In this character rotation process, depending on the movement direction of the touch pen 7, the rotational direction of the player aircraft character 70 is set to the right (clockwise) in cases in which the upper right direction shown in FIG. 4B is set, for example, and the rotational angle of the player aircraft character 70 increases as the movement distance of the touch pen 7 increases. In FIG. 4A, the nose 70a of the player aircraft character 70 is oriented somewhat upward and to the right, i.e., towards the enemy aircraft character 71. The movement speed of the touch pen 7 is then computed on the basis of the data of the first contact position 80 and the second contact position 81 (S27). When the movement speed of the touch pen 7 is computed, a character speed variation process is performed to vary the speed of the player aircraft character 70 in accordance with the movement speed of the touch pen 7 (S28). In the character speed variation process, images corresponding to the movement speed of the touch pen 7 are selected in order to display a blur of motion around the periphery of the player aircraft character 70. When the character rotation process is performed, a character propulsion process is performed to propel the player aircraft character 70 in a specific direction; i.e., to propel the player aircraft character 70 so as to be oriented towards the enemy aircraft character 71 (S29). The player aircraft character 70 that has moved according to the results of the character rotation process and the character propulsion process is then displayed on the upper liquid crystal monitor 3a (S30). Furthermore, a blur of motion selected according to the results of the character speed variation process is displayed on the upper liquid crystal monitor 3a (830). In FIG. 4A, an image is displayed in which the nose 70a of the player aircraft character 70 advances towards the enemy aircraft character 71, and a blur of motion (not shown) is displayed around the periphery of the player aircraft character 70.

When the touch pen 7 is kept in contact without moving in step S22, a character propulsion process is performed to propel the player aircraft character 70 without rotating the player aircraft character 70 (S29). The player aircraft character 70 that has moved according to the results of the character propulsion process is then displayed on the upper liquid crystal monitor 3a (S30). FIGS. 6 and 7 show images in which the nose 70a of the player aircraft character 70 is propelled without rotating.

Lastly, a determination is made as to whether or not the touch pen 7 has separated from the lower liquid crystal monitor 3b (S31). When the touch pen 7 has not separated from the lower liquid crystal monitor 3b, the current first contact position 80 is reset, the process moves to step S21, and the current second contact position 81 is recognized as the new first contact position 80. When the touch pen 7 has separated from the lower liquid crystal monitor 3b, the current first contact position 80 and the second contact position 81 are reset and the process is ended.

In the shooting game processed in this manner, the touch pen 7 is operated with the right hand to give movement direction instructions and propulsion instructions for the player aircraft character 70, while the input unit 4 is simultaneously utilized with the left hand to attack the enemy aircraft character 71. Therefore, since the intended operations of the player can be readily reflected in the game, the operability of the game is improved, and a high level of enjoyment in the game is maintained for the player. Furthermore, since a character speed variation process is performed to vary the speed of the player aircraft character 70 in accordance with the movement speed of the touch pen 7, a blur of motion is displayed around the periphery of the player aircraft character 70, and a higher level of enjoyment in the game is therefore maintained for the player.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A computer readable medium encoded with a game program for executing a game on a computer, the game program instructing the computer to perform the steps comprising:
recognizing a contact position of an instruction member on a monitor when the instruction member is brought into contact with the monitor;
recognizing a movement direction in relation to the contact position when the instruction member is moved across the monitor;
recognizing a movement distance from the contact position within a specific time period when the instruction member is moved across the monitor;
rotating a character so that the character faces a specific direction in accordance with the movement direction and the movement distance;
propelling the character in the specific direction while the instruction member is in contact with the monitor; and
displaying the rotating the character and the propelling the character on the monitor.

2. The computer readable medium as recited in claim 1, wherein
the propelling the character in the specific direction is performed when the instruction member is brought into contact with the monitor and is not moved across the monitor.

3. The computer readable medium as recited in claim 1, wherein
a rotational angle of the character increases as the movement distance increases.

4. The computer readable medium as recited in claim 3, wherein
the rotational angle of the character is maintained when a specific movement distance is exceeded, and the rotational angle of the character increases from the maintained rotational angle as the movement distance increases when the instruction member is moved across the monitor to a different position than the contact position.

5. The computer readable medium as recited in claim 1 further instructing the computer to perform the steps comprising:
recognizing movement speed in relation to the contact position when the instruction member is moved across the monitor;
varying the movement speed of the character in accordance with the movement speed in relation to the contact position; and
displaying the varying the movement speed of the character.

6. A game device comprising:
a contact position recognition section configured to recognize a contact position of an instruction member on a monitor when the instruction member is brought into contact with the monitor;
a movement direction recognition section configured to recognize a movement direction in relation to the contact position when the instruction member is moved across the monitor;
a movement distance recognition section configured to recognize a movement distance from the contact position within a specific time period when the instruction member is moved across the monitor;
a character rotation section configured to rotate a character so that the character faces a specific direction in accordance with the movement direction and the movement distance;
a character propulsion section configured to propel the character in a specific direction while the instruction member is in contact with the monitor; and
a character display section configured to display the rotating the character and the propelling the character on the monitor.

7. A game method comprising:
recognizing a contact position of an instruction member on a monitor when the instruction member is brought into contact with the monitor;
recognizing a movement direction in relation to the contact position when the instruction member is moved across the monitor;
recognizing a movement distance from the contact position within a specific time period when the instruction member is moved across the monitor;
rotating a character so that the character faces a specific direction in accordance with the movement direction and the movement distance;
propelling the character in a specific direction while the instruction member is in contact with the monitor; and
displaying the rotating the character and the propelling the character on the monitor.
